(19) United States
(12) Patent Application Publication
(10) Pub. No.: US 2004/0066435 A1
(43) Pub. Date: Apr. 8, 2004

(54) Method and means for configuring a printer

(76) Inventors: Samuel M. Lester, Boise, ID (US); Jimmy Sfaelos, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/266,460

(22) Filed: Oct. 8, 2002

(51) Int. Cl. B41J 2/175

(52) U.S. Cl. 347/86

(57) ABSTRACT

A label included with a printer cartridge is detected to determine if the label is recognized. When the label is not recognized, a printer engine is configured with default printing properties. If the label is recognized, then the label printing properties included on the label are read and used to configure the printer engine.

### FIELD OF THE INVENTION

The present invention relates to printing technology, and in particular to method and means for configuring a printer.

### BACKGROUND OF THE INVENTION

A printer connects to a printer cartridge to receive ink/toner that is then ejected in order to produce an image on print media (e.g., paper, envelope, business card, slide, and the like). The type of printer cartridge dictates how the printer interacts with the printer cartridge. If the printer cartridge is not recognized, then with conventional printers print jobs are not permitted to proceed, since the printer does not attempt to guess or decide a minimal set of printing properties that would permit the print jobs to process on the printer.

Printing properties include, by way of example only, a resolution or density of a print image (e.g., Dots Per Square Inch (DPI)), a printer speed (e.g., Pages Per Minute (PPM)), color settings (e.g., color selection, color intensity, and the like), simplex or duplex settings (e.g., print on a single side of a print media or both sides of the print media), indications to process image enhancing algorithms, heat fuser/dry time, and the like. Additionally, in some instances with laser printers, if a duplex setting is used for a print job and the ink/toner is not fused onto the paper fast enough, then the ink/toner will streak on the paper. Even when the printer recognizes the printer cartridge being used, often the printing properties are not optimized for the type of print job being performed. One type of print job can print a letter requiring 300 DPI or less. Alternatively, another print job can print a photograph requiring 1200 DPI or more, and the photograph may require image enhancing algorithms, such as image scaling, dithering (e.g., approximating a color from a mixture of other colors when the required color is not available), and the like.

### BRIEF DESCRIPTION OF THE DRAWINGS

FIG. 1 is a flowchart illustrating a method to configure printing properties, according to one embodiment of the present invention.

FIG. 2 is a flow chart illustrating a method of printer instructions to configure printing properties, according to one embodiment of the present invention.

FIG. 3 is a block diagram including a printer cartridge, according to one embodiment of the present invention.

FIG. 4 is a flowchart illustrating an instruction set to configure printing properties, according to one embodiment of the present invention.

FIG. 5 is a block diagram of a printing system for configuring printing properties, according to one embodiment of the present invention.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage media (e.g., volatile, non-volatile, removable, fixed, and the like). The term “computer readable media” is also used to represent carrier waves on which the software is transmitted. Further, such functions correspond to modules, which are software, hardware, and firmware or any combination thereof. Multiple functions are performed in one or more modules as desired, and the embodiments described are merely examples.

Moreover, in various embodiments of the present invention, a printer cartridge label is an electronic chip. Further, in some instances, the label can be a Radio Frequency (RF) chip such that when the chip is placed within proximity of a receiving device communications between the chip and the receiving device can commence. Of course as one of ordinary skill in the art readily appreciates, any type of computer readable medium can be used to implement the printer cartridge label of the present invention. All such types are intended to fall within the scope of the present disclosure.

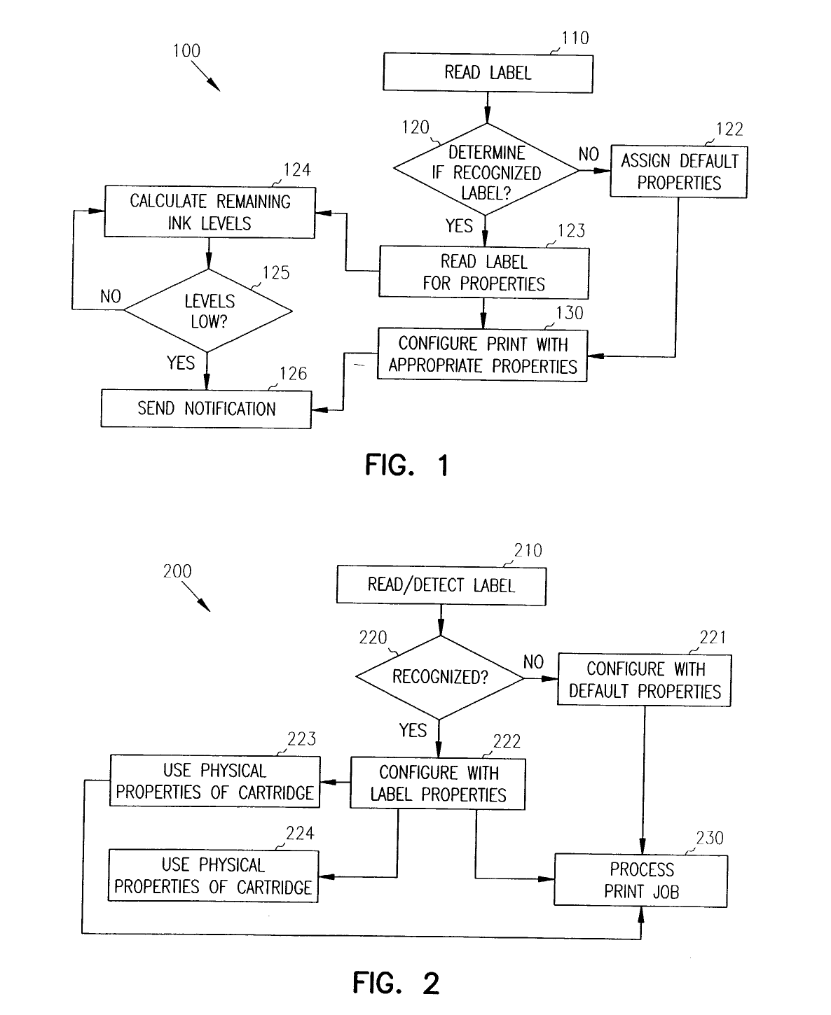

FIG. 1 is a flowchart illustrating one method 100 to configure printing properties, according to one embodiment of the present invention. As an overview, a printer receives a printer cartridge. The printer cartridge includes inkwells having one or more colors included therein (e.g., black or multiple colors). The printer cartridge is instructed to deliver ink/toner in certain quantities by firmware or software. In some embodiments, the firmware or software resides in the printer. In other embodiments, the firmware or software reside in computing devices that is remote from the printer. A printer cartridge label is affixed to the printer cartridge. The label includes print properties, such as printing resolution or density, indications as to whether enhanced imaging applications are to be processed, color settings, printing speed, and the like. In some embodiments, the label includes an identification, and a printing engine uses the identification to acquire the print properties from a driver table, or from a website (e.g., download the print properties from a remote site). Thus, the label need not include the print properties.

At 110, the printer firmware or software reads the printer cartridge label, and at 120 the firmware/software determines if the printer cartridge label is a recognized label. In some embodiment, if the initial read fails at 110, then the printer firmware or software knows that the printer cartridge label is a non standard or unrecognized printer cartridge label. Typically, vendors provide their own printers and printer cartridges; some vendors provide enhanced print capabilities for their printer cartridges, since these cartridges conform to the capabilities of their printers. Generally, if a printer detects an unknown printer cartridge label, then print jobs are not processed on the printer, since the results of a print job can produce unexpected results (e.g., incorrect margins, incorrect fonts, incorrect resolution, and the like).

In various embodiments of the present invention, if the label on the printer cartridge is unrecognized by the printer's firmware/software, then at 122 the firmware/software will assign default-printing properties to any print jobs processing in the printer. For example, the PPMs can be decreased, the DPI can be decreased, and enhanced applications (e.g., interpolation, scaling, dithering, and the like) will not be executed. In one embodiment, the default printing properties is a least common denominator of printing property settings for commercially available printing cartridges, irrespective of which vendor supplies the cartridges.

At 123, if the label was recognized by the firmware/software of the printer, then the label is read to acquire the printing properties included on the label. Alternatively, label identifications can be used to acquire the printing properties (e.g., driver table, web site, and the like). Each instance of a recognized label can include customized printing properties, designed to improve the performance of a type of print job. For example, one instance of a recognized label can be geared towards increasing print job throughput and decreasing the use of ink/toner, such as when the owner of the print jobs is primarily issuing print jobs that are by and large draft text documents. Alternatively, another instance of a recognized label can be geared towards print jobs that are focused on quality having a plurality of colors (e.g., presentations, pictures, and the like).

Furthermore, the printing properties can be used to determine the different reflectivity properties of colors. For example, a color table can identify flat black and glossy black. Thus, specialized colors can be distributed on customized labels that will be recognized by a printer engine, based on properties or identifications included in the printer cartridge. In this way, the printing cartridges of the present disclosure can be customized and sold with unique labels that are tailored to the needs of users. Customization is achieved, by encoding optimal printing properties on the labels (or identifications to acquire the printing properties) of the printing cartridges. The optimal printing properties conform to optimal settings for specific types of desired print jobs from a consumer. The firmware or software in communication with the printer then reads the printing properties and configures the printer engine accordingly to optimally process the print jobs.

At 124, and in one embodiment, if the label is recognized by the firmware/software of the printer, then the firmware/software can keep track of the amount of ink/toner dispensed from the printer cartridge. Thus, the firmware/software can calculate the amount of used ink/toner within the cartridge and the amount of remaining levels of ink/toner within the cartridge. Accordingly, at 125, if the ink/toner levels are low, an electronic notification can be sent to an owner of a print job processing on the printer, as depicted at 126. Again, the electronic notification can be generated entirely within the printer's computing environment, or in some embodiments, the electronic notification can be sent to and recorded by a vendor of the printer cartridge.

Once the printing properties within a printing engine, then at 130 the print job is processed on the printer, resulting in an image of the print job being transferred to print media. In some embodiments of the present disclosure, the printer is a standalone-printing appliance (e.g., photo printer), and in other embodiments, the printer is networked and receives commands through a computing device (e.g., server, personal computer, workstation, digital camera, video camera, mainframe, and others). Additionally, in some embodiments, the printer cartridge is a laser toner cartridge, an inkjet printer cartridge, or another consumable colorant package (e.g., toner bottle) that is commonly used.

FIG. 2 is a flow chart illustrating one method of printer instructions 200 to configure printing properties of a printer, according to one embodiment of the present invention. At 210 a printer cartridge that is in communication with a printer includes a printer cartridge label, which is read or detected. At 220, the type of printer cartridge label is determined by a firmware/software set of executable instructions processing on the printer. The firmware/software determines the type of printer cartridge label by determining whether it recognizes the printer cartridge label. For example, if the firmware/software is unable to read the printer cartridge label (e.g., a read operation fails), then the firmware/software concludes the printer cartridge label is unrecognized. In some cases, the firmware/software can read foreign printer cartridge labels, and in these cases, the firmware/software looks for a printer cartridge label identifier to determine if the printer cartridge label is recognized or unrecognized.

If the firmware/software does not recognize the printer cartridge label, then at 221, a printer engine processing on the printer is configured with a set of default printing properties. In one embodiment, the default printing properties include reduced DPI, PPMs, and lack any enhanced image manipulation algorithms (e.g., interpolation, scaling, dithering, and the like). However, any default printing properties can be selected, such that the default properties represent the safest settings (e.g., least likely to cause printer problems) for an unrecognized printer label cartridge. Thus, unrecognized printer cartridge labels receive a least common denominator (e.g., safe) set of printing properties, which permits the firmware/software to process a print job, albeit sometimes at a lower print quality and lower printer speed. Thus, method 200 produces a better image on print media with the least amount of harm to the printing device; wear and tear (e.g., excess toner removal from rollers or transfer belts, and the like).

If the firmware/software does recognize the printer cartridge label, then at 222, the printing properties included on the printer cartridge label are read and used to configure the printer engine accordingly. In some embodiments, the label is customized with printing properties that are geared towards processing specific types of print jobs, toner qualities, or variations of colors (e.g., color tables). Therefore, users can purchase printing cartridges with customized printing cartridge labels that improve the quality and performance of the print jobs that they typically desire.

Furthermore, at 223, if the printer cartridge label is recognized, then the firmware/software can dynamically determine the ink/toner levels of the printer cartridge. The ink/toner levels can be electronically communicated to a user upon a request, or automatically when the ink/toner levels fall below a predefined threshold level. Additionally, when the printer cartridge label is recognized, the firmware/software on the printer can dynamically establish parameters for maximum printing speed and best image quality for the printer engine as these parameters relate to the physical properties of the printer cartridge. In some embodiments, the physical properties of the printer cartridge include a particle size setting, a melting point setting, a color setting, an electrostatic charge setting, and the like. Therefore, the firmware/software can more intelligently configure the printer engine to match the performance capabilities of the printer cartridge, when the printer cartridge label is recognized by the firmware/software.

Once default printing properties or customized label printing properties is configured within the printer engine, then at 230, a print job is permitted to process on the printer resulting in an image of the print job being transferred to print media. As one of ordinary skill in the art now appreciates, the tenets of the present disclosure permit the use of a variety of print cartridges (e.g., from different vendors) with a printer supplied by a specific vendor. Moreover, print cartridges can be purchased to maximize performance and quality for certain types of print jobs. This added level of customization offers improved printing alternatives to consumers.

In some embodiments, the printing device can include more than one printer cartridges. For example, the printing device can include one cartridge for color and one cartridge for black. Alternatively, and by way of example only, the printing device can include 3 black cartridges, one for glossy black, one for flat black, and one for magnetic used for checks. Thus, a plurality of cartridges can be used in various embodiments of the present invention, and the disclosure is not limited to a single cartridge.

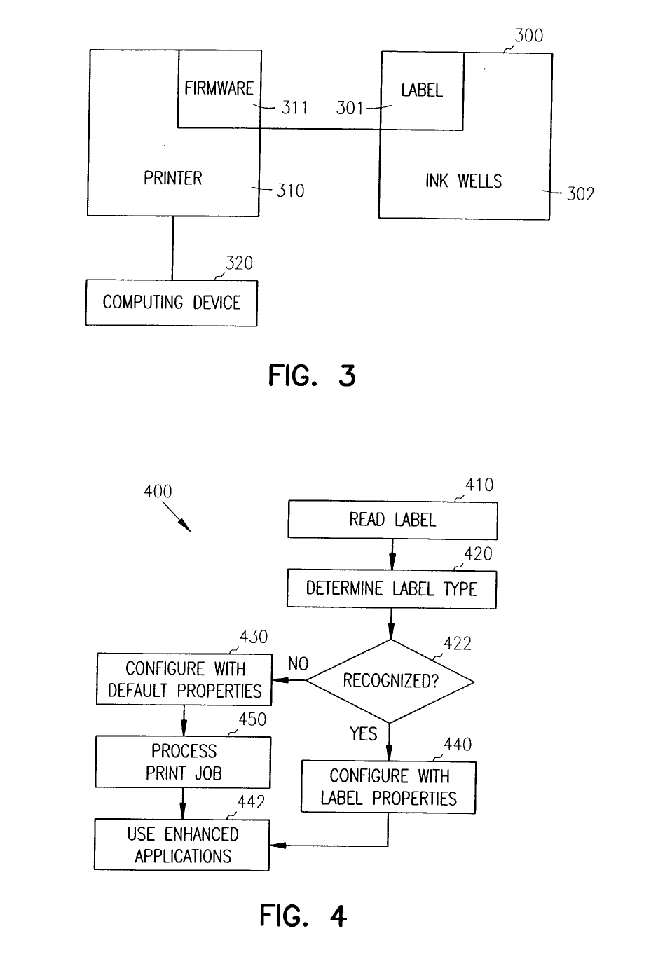

FIG. 3 is a block diagram including one printer cartridge 300, according to one embodiment of the present invention. The printer cartridge 300 includes one or more inkwells 302 housing a single color and/or multiple colors of ink/toner. The printer cartridge 300 also includes a label 301. When the label 301 is placed in communication with a printer 310, firmware/software 311 executing on the printer 310 reads the label 301 to determine the customized printing properties residing on the label 301. In some embodiments, the customized printing properties are acquired from a driver or downloaded from a website, once the identity of the label 301 is determined. In one embodiment, the printer 310 receives print jobs from a computing device 320 (e.g., workstation, personal computer, mainframe, digital camera, video camera, and others). In other embodiments, the printer 310 is a standalone appliance (e.g., photo printer, kiosk, and the like) where print jobs are directly scanned or communicated via a removable computer readable medium to the printer 310.

The firmware/software 311 uses the customized printing properties included on or identified by the label 301 to configure the printer 310 in order to process print jobs based on the customized printing properties. The customized printing properties include resolution settings, color settings, printing speed settings, simplex or duplex settings, and the like. The customized settings, in one embodiment, are preset and distributed by a vendor based on types of print jobs or color variations that are desired. For example, a printer cartridge 300 can be distributed to optimally process letters, while another printer cartridge 300 can be distributed to optimally process photographs. Thus, the printer cartridges 300 of the present disclosure are flexible and tailored to meet the printing preferences of consumers. In some cases, these preferences can be based on the consumer's need for a specific DPI printing resolution and/or a specific PPM printing processing speed. In other cases the preferences, can be the consumer's desire to have customized image enhancement applications (e.g., interpolation, scaling, and the like) processed against printed images. Alternatively, if a label is not recognized a safest setting for the printing properties is selected for the print jobs and configured accordingly within the printer 310. Thus, print jobs associated with unrecognized labels can still be processed on the printer 310. By way of example, and not by way of limitation, safe settings for printing properties can include 150 DPI, 8 PPM, no interpolation processing, simplex mode, no supply alerts, and the like.

FIG. 4 is a flowchart illustrating one instruction set 400 to configure printing properties, according to one embodiment of the present invention. The instruction set 400 resides in a single computer readable medium or a plurality of computer readable media. The instruction set 400, in one embodiment, is implemented as a firmware set of executable instructions on a printer. In an alternative embodiment, the instruction set 400 is implemented in a device driver for the printer. In still other embodiments, the printer remotely processes the instruction set 400. Moreover, the printer can receive printer jobs from another computing device or it can receive the printer jobs directly (e.g., such as when the printer is a standalone appliance).

At 410 a label of a printer cartridge is read, the printer cartridge is in communication with the printer and the instruction set 400 has access to read the label either directly from the printer (e.g., firmware) or indirectly through Application Programming Interface (API) calls to the printer. At 420, the type of label is determined when it is either recognized or unrecognized. The label type can be associated with a specific vendor supplying the printer cartridge having the label. Accordingly, at 422, the label type is checked to determine if it is recognizable by or supported by the instruction set 400.

If the label is unrecognized or unsupported, then at 430 the printer is configured by the instruction set 400 with a set of default (e.g., safe) printing properties/settings. In some embodiments, the default printing properties include slower printing speeds and lower printing qualities than what is available with recognized and supported labels. In this way, the instruction set 400 provides a safe set of default properties that can support printer cartridges from a plurality of vendors that are disparate from the vendor of the processing printer.

If the label is recognized and supported, then at 440 the label properties included on the label (or acquired remotely) are used to configure the printer before processing the print job. In some embodiments, the label properties include indications that permit the instruction set 400 to process one or more enhanced imaging applications (e.g., interpolation, scaling, and others) for the print job, as depicted at 442. Thus, the quality of the image produced from the printer can be enhanced when the label includes properties that are associated with executing enhanced imaging applications. The properties can also be used to increase the fusing temperature when duplex prints are desired, if the physical qualities of the printing cartridge indicate that this is necessary. Moreover, the properties can include color variations to enhance the color needs of a consumer (e.g., flat versus glossy, and the like).

Once the default printing properties or customized label-printing properties are used to configure the printer, the print jobs are processed at 450. As one of ordinary skill in the art now appreciates, a printer provided by a first vendor can use the teachings of the present disclosure to permit printing cartridges of a plurality of different vendors to be used within the printer. Moreover, the first vendor can market and distribute customized printing cartridges having different label printing properties to meet the individual printing needs and preferences of its customers.

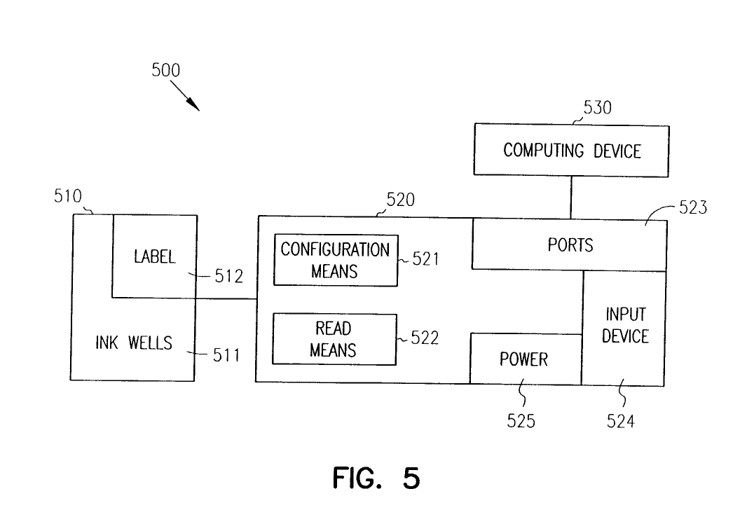

FIG. 5 is a block diagram of one printing system 500 for configuring printing properties, according to one embodiment of the present invention. The printing system 500 includes a printing cartridge 510 and a printer 520. In some embodiments, the printing system 500 also includes a computing device (e.g., workstation, server, mainframe, personal digital assistant, digital camera, video camera, and the like). Although, the printing system 500, in some embodiments, operates as a standalone system, such as a kiosk, photo printer, or when the printer 520 is capable of operating as a standalone appliance.

The printer 520 includes, among other things, a configuration means 521 for configuring print jobs requested on the printer 520, and a reading means 522 for reading or attempting to read the printing cartridge's label 512. The configuration means 521 can include a raster image processor, applications to perform interpolation, applications to perform scaling or dithering, applications to set the printer 520 speed, applications to send supply alerts, and the like. The reading means includes applications that read or acquire data from the printer cartridge's label 512. The data can be in the form of instructions that are provided to the configuration means 521 for direct processing. Alternatively, the data can be parameter values that are used by the configuration means to cause processing of one or more applications included within the configuration means 521.

In some embodiments, the printer 520 also includes one or more external ports 523 for communicating with external devices 530 and/or media, an input device 524 to receive direct commands from an operator, and a power supply connection device 525. The printer 520 can include additional devices, such as integrated scanners, media feeders, integrated facsimiles, integrated network connections, integrated modems, and others. All such configurations of printer 520 are intended to fall within the gratuitous scope of the present disclosure.

One embodiment of FIG. 5 depicts the printer 520, which is placed in communication with the cartridge 510. Communication can be achieved by physically snapping the cartridges 510 into the printer 520. The one or more cartridges 510 include one or more inkwells 511, which are of a single color or a multitude of colors. The one or more cartridges 510 can also each include a label 512 that is used by the printer 520 to communicate with the cartridge 510. Label 512 is a computer readable medium that includes information (e.g., electronic chip, and the like), which is used by the printer 520.

In some embodiments, the label 512 is media that indicates a set of customized printing properties/parameters, which are read or acquired by the reading means 522, after the cartridge 510 is placed in communication with the printer 520. In other instances, the label 512 includes an identifier that is used by the printer to remotely acquire the printing properties/parameters. The customized printing properties include printing resolution settings, printing speed settings, simplex settings, duplex settings, color settings, melting point settings, dry time settings, pressure settings, indications to process desired image enhancing applications, and the like. In some embodiment, the reading means passes the printing properties to the configuration means 521, and the configuration means 521 uses the customized printing properties and the known type (e.g., vendor) of cartridge 510, to optimally configure the printer 520 for processing print jobs issued to the printer 520 by accessing one or more applications associated with the configuration means 521.

In some embodiments, the means for configuring 521 can also process applications that keep track of the ink/toner levels that remain and have been used in the inkwells 511 of the one or more cartridges 510. In this manner, electronic notifications can be sent to print job owners when ink/toner levels approach a threshold level. Additionally, in some cases, ink/toner usage can be communicated electronically to a vendor of a cartridge 510 and/or a vendor of the printer 520. As such, a vendor can analyze and provide automated services to one or more print job owners based on the ink/toner usage. For example, a job owner may desire that the vendor automatically ship a new cartridge when the ink/toner usage level nears the threshold without any manual intervention by the print job owner. Alternatively, such a vendor can supply volume discounts on cartridges to the job owner when the job owner's ink/toner usage approaches a discount level. It is readily apparent upon reading this disclosure that a variety of automated usages can occur when the ink/toner usage and levels are automatically calculated. All such automated usages are intended to fall within the scope of the present invention.

In some embodiments, the configuring means 521 is implemented as a set of firmware executable instructions residing within the printer 520. Although, the configuration means 521 is depicted in FIG. 5 as residing within the printer 520, one of ordinary skill in the art readily appreciates, the invention is not so limited, since in other embodiments the configuration means 521 can be remotely accessed and processed by the printer 520. Moreover, the configuration means 521 need not be a single software application, since in some embodiments; the configuration means 521 is a plurality of software applications in communication with one another.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to one of ordinary skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method of configuring printing properties, comprising:
determining if a printer cartridge label is recognized with a printer cartridge;
reading the printer cartridge label, if recognized, and configuring a printer engine with label properties identified by the printer cartridge label; and
configuring the printer engine with default properties if the printer cartridge label is not recognized.

2. The method of claim 1 wherein in determining, the printer cartridge is a laser printer toner cartridge.

3. The method of claim 1 wherein the determining, the reading, and the configuring are processed by a firmware set of executable instructions residing in a printer.

4. The method of claim 1 wherein in reading and in configuring, the label properties and the default properties include at least one of a resolution value for Dots Per Square Inch (DPI), a simplex or duplex value, a printing speed identified by a Pages Per Minute (PPM) value, and color setting values.

5. The method of claim 1 further comprising, calculating a remaining ink/toner level for the printer cartridge based on a number of prior print jobs processed when the printer cartridge label is recognized.

6. The method of claim 5 further comprising, sending an electronic notification when the remaining ink/toner level is below a threshold value.

7. The method of claim 1 wherein in reading the printer cartridge label, the label properties are remotely acquired by the printer engine.

8. A method of printer instruction processing, comprising;
detecting if a printer cartridge includes a recognizable printer cartridge label;
configuring a printer to process a print job based on one or more label properties included on the recognizable printer cartridge label; and
configuring the printer to process the print job using default properties when the printer cartridge label is not detected.

9. The method of claim 8 wherein in detecting, the printer cartridge label is an electronic chip.

10. The method of claim 8 wherein in configuring the printer to process the print job based on the one or more label properties, the printer cartridge label is used to determine an ink/toner level remaining in the printer cartridge.

11. The method of claim 8 wherein in configuring, the label properties and the default properties include at least one of a resolution value, a printer speed value, and color settings.

12. The method of claim 8 wherein in configuring the printer to process the print job based on the label properties, the label properties permit a firmware set of executable instructions within the printer to dynamically establish a maximum printer speed and an optimal image quality for the print job based on physical properties of the printer cartridge.

13. The method of claim 12 wherein in configuring the printer to process the print job based on the label properties, the physical properties include a particle size setting, a melting point setting, color mixing settings, and an electrostatic charge setting.

14. A printer cartridge, comprising:
an inkwell housing one of more colors of ink/toner; and
a printer cartridge label including customized printing properties or an identification for the customized printing properties that identify at least one of resolution settings, color settings, and printing speed settings for print jobs using the printer cartridge.

15. The printer cartridge of claim 14 wherein a firmware set of executable instructions residing in a printer uses the printer cartridge to read the printer cartridge label and acquire the customized printing properties, and wherein the printing properties are used by the firmware set of executable instructions to configure a printer engine for processing the print jobs based on the settings.

16. The printer cartridge of claim 14 wherein the customized printing properties are preset and distributed based on preferences for the print jobs.

17. The printer cartridge of claim 16 wherein the preferences are based on a required Dots Per Square Inch (DPI) printing resolution or color variations used for the print jobs.

18. A computer readable medium having instructions for configuring printing properties, the instructions comprising:
reading a label of a printer cartridge;
determining if the label is a recognized label;
configuring a printer engine to use label properties included on the label or identified by the label, if the label is the recognized label; and
configuring the printer engine to use default properties if the label is unrecognized.

19. The instructions of claim 18 wherein the instructions are firmware that executes within a printer.

20. The instructions of claim 18 further comprising, using one of more interpolation, dithering, and scaling applications for a print job when the label is the recognized label.

21. The instructions of claim 18 wherein in configuring the printer engine to use the default properties, the default properties include a slower printing speed and a lower print image resolution than a print job that includes the recognized label.

22. A printing system comprising:
a cartridge including a printer cartridge label that has customized printing properties identified for print jobs;
means for reading the printer cartridge label; and
means for configuring a printer to process the print jobs by acquiring the customized printing properties from the means for reading and configuring the printer to process the print jobs by using the customized printing properties.

23. The printing system of claim 22 wherein the printer receives the printer cartridge and executes the means for configuring after communicating with the means for reading.

24. The printing system of claim 23 wherein the means for configuring the printer is firmware embedded in the printer.

25. The printing system of claim 22 wherein the means for configuring the printer keeps track of ink/toner levels within the printer cartridge and sends a notification when the levels dip below a threshold.

26. The printing system of claim 22, wherein the printer properties include settings for processing the print jobs, and the settings include values for at least one of a printer resolution, a printer speed, a setting for simplex or duplex printing, settings for color, a setting for melting point, a setting for dry time, and a setting for pressure.
